(19) United States
(12) Patent Application Publication
(10) Pub. No.: US 2020/0198171 A1
(43) Pub. Date: Jun. 25, 2020

(54) ERGONOMIC CHAINSAW WITH HIGH OPERATION SAFETY

(71) Applicant: Changzhou Globe Co., Ltd., Changzhou, Jiangsu (CN)

(72) Inventor: Jens Naeslund, Spaanga (SE)

(21) Appl. No.: 16/609,892

(22) PCT Filed: Sep. 27, 2017
(86) PCT No.: PCT/CN2017/103732

§ 371 Date: Oct. 31, 2019

(51) Int. Cl. B27G 19/00; B27B 17/02; A01G 3/08

(52) U.S. Cl. CPC B27G 19/003; A01G 3/086; B27B 17/02

(57) ABSTRACT

A chainsaw which has a motorized chain that is suitable for sawing and trimming objects. The chainsaw includes a motor housing comprising a side portion, a chain, a guide bar, an electric motor, and a front handle. Safer handling and ergonomics is achieved by the motor housing comprising a concave contour on part of the surface of the side portion.

### TECHNICAL FIELD

The present invention relates to an ergonomic chainsaw with high operation safety.

### BACKGROUND ART

A chainsaw operates through an endless chain loop that pulls material away in a series of chipping actions. Examples of prior art chainsaws are disclosed in U.S. Pat. Nos. 5,245,757 and 3,651,839. However, U.S. Pat. Nos. 5,245,757 and 3,651,839 are silent about operation safety and the ergonomics of chainsaws.

As disclosed in an article titled “Preventing chain saw injury” from October 2010 in www.isa-arbor.com, “laceration” is the medical term given to the majority of chainsaw injuries [1]. The article further explains that a laceration is an injury that breaks the skin, and this definition is sometimes expanded to mean a torn and ragged cut—precisely what might occur from a chain pulling on tissue. These lacerations can occur anywhere on the body, although they tend to predominate on the left side due to the way the saw is typically held. Lacerations involving a chain saw are often described as deep and multiple, usually a series of parallel cuts. Chain saw accidents can also result in fractures and amputations, as well as severed tendons and nerves. Tree workers have been left partially paralyzed as a result of saw cuts.

Chainsaw accidents occur all over the world. As an example, the number of chainsaw injures in USA from loggers, arborists, other professionals, as well as homeowners, ranged from 40 000 to 90 000 each year for severe, non-fatal accidents [1]. More importantly, death occurred in another 40 to 60 accidents.

The majority of accidents and deaths can be divided into two basic categories referred to as “cut through” and “kickback” injuries as disclosed in US20110203123. “Cut through” injuries occur when the user cuts through the material he or she is cutting and into their own lower extremities, generally their left upper thigh or lower legs or feet. Injuries caused by kickback can be more dangerous. When the user operator grips the saw by the handles, the chain naturally sets dangerously close to the left leg of the user. This position becomes even more pronounced and hazardous when the user becomes fatigued and therefore brings the saw closer to the body which in turn angles the chainsaw even further left; i.e., the operator brings the right hand/rear handle of the saw toward the right side of the waist and brings the left hand closer to the body so as to relieve muscle strain the in arms, shoulder, and back.

The solution typically provided for reducing injures and extent of damage by lacerations is (i) chainsaw awareness training, (ii) chain saw first aid training, and (iii) to use personal protective equipment [1]. Examples of protective wear for chain saw users is disclosed in U.S. Pat. No. 5,987,778. However, training and protective equipment does not provide a safer chainsaw. Moreover, training and protective equipment does not provide a chainsaw which is safe to use when the user is fatigued. Hence, there is a need for safer chainsaws, i.e. there is e need for a chainsaw with high operation safety. Moreover, there is also a need for chainsaw which does not give rise to fatigue, i.e. there is a need for an ergonomic chainsaw.

A further solution provided in the prior art for reducing injures and extent of damage is disclosed in US20110203123. The solution in US20110203123 is accomplished by a dual stage multi-hinged bar device that physically inhibits kickback and cut through injuries. The device, which returns to its original position after cutting, will open up a total of 88 degrees to allow for cutting of items that are larger than the length of the guide bar. Relocation of the handles leads users toward physically holding the saw in such a manner that creates an ergonomically advantageous body position, reducing fatigue and strains. The body of the saw and the bar device will rotate 45 and 90 degrees both right and left while the handles and operators grip remain in the same position. However, the solution disclosed in US20110203123 involves many additional parts which have to be integrated with a chainsaw which results in the chainsaw becoming complex, and heavier, as well as more expensive products. Hence, there is a need for a simpler, lighter and more cost-efficient way of providing a solution to the problem of “cut through” and “kickback” injuries.

### OBJECT OF INVENTION

The object of the invention is to provide safe operation of the chainsaw.

A further object of the invention is to provide an ergonomic advantageous operation of the chainsaw.

A further object of the invention is to reduce or eliminate the incidents of “cut through” and “kickback” injuries.

A further object of the invention is to provide a simpler chainsaw in which the operational safety and ergonomics of the chainsaw is provided by a simple and cost-efficient design.

### SUMMARY OF INVENTION

The objects of the present invention are attained by the invention disclosed in the present claims.

The present invention relates to a chainsaw having a high operational safety. Moreover, the present invention is also related to an ergonomic chainsaw which is designed and configured so that when it is used, it will maximize productivity by minimizing operating fatigue and discomfort.

The preferred embodiment of the invention relates to a portable chainsaw with motorized chain suitable for sawing and trimming objects, comprising,
a. a motor housing comprising a side portion,
b. a chain and a guide bar for guiding the chain,
c. an electric motor for driving the chain, wherein said motor is contained in the motor housing of the chainsaw,
d. a front handle,
   wherein the motor housing comprises a concave contour on part of the surface of the side portion.

In a further preferred embodiment, the curvature of the concave contour is configured for substantially fitting against a part of the leg of a user.

In a further preferred embodiment, the curvature of the concave contour is configured for fitting against a part of the leg of a user.

In a further preferred embodiment, the curvature of the concave contour on part of the surface has a greater degree of curvature than the general curvature of the whole side portion.

In a further preferred embodiment, the concave contour extends longitudinally at said side portion.

In a further preferred embodiment, the concave contour is apertureless.

In a further preferred embodiment, the side portion is apertureless.

In a further preferred embodiment, the part of the side portion which is configured to be in contact with the user's leg or hip is apertureless.

In a further preferred embodiment, the part of the side portion which will be in contact with the user's body is 2-20 cm long and starts from the end of the curvature of the concave contour closest to the rear portion of the chainsaw and extends in the longitudinal direction towards the rear portion of the chainsaw.

In a further preferred embodiment, the radius of curvature of the concave contour is 2 to 20 cm, preferably 5-17 cm, more preferably 8-14 cm, most preferably 10-12 cm.

In a further preferred embodiment, the longitudinal length of the curvature of the concave contour is 2 to 20 cm, preferably 5-17 cm, more preferably 8-14 cm, most preferably 10-12 cm.

In a further preferred embodiment, the concave contour is configured for being in contact with a convex contour of a user's leg.

In a further preferred embodiment, 30-100% of the surface of the concave contour in configured to be in contact with the user's leg.

In a further preferred embodiment, the electric motor is powered by a battery pack, fuel-cell, solar panel and/or power cord.

### BRIEF DESCRIPTION OF DRAWINGS

The invention is now described, by way of example, with reference to the accompanying drawings, in which:

FIG. 1 (a)(b)(c) illustrates three different embodiments of a concave contour.

FIG. 2 is a top view of an embodiment of the chainsaw according to the present invention.

FIG. 3 is a perspective view (from top-rear perspective) of the chainsaw illustrated in FIG. 2.

FIG. 4 is a perspective view (from bottom-rear perspective) of the chainsaw illustrated in FIG. 2.

### DESCRIPTION OF EMBODIMENTS

The present invention relates to an ergonomic portable chainsaw having high operational safety wherein the chainsaw has a motorized chain for sawing and trimming objects such as trees and bushes. The term ergonomic chainsaw is used in the present invention to define a chainsaw which has design and configuration features, which when the chainsaw is used, will maximize productivity by minimizing operating fatigue and discomfort.

The chainsaw comprises a motor housing comprising a side portion, a chain, a guide bar for guiding the chain, an electric motor for driving the chain and a front handle. The electric motor of the chainsaw may be powered by a battery pack, a fuel-cell, a solar panel and/or a power cord. The motor housing comprises a concave contour on part of the surface of the side portion. The curvature of the concave contour is preferably configured for fitting against a part of the leg of a user. The curvature of the concave contour may alternatively be configured for fitting against a part of the hip of a user.

As previously indicated, “cut through” injuries occur when the user cuts through the material he or she is cutting and into their own lower extremities, generally their left upper thigh or lower legs or feet. The present invention reduces the risk of “cut through” injuries since concave contour fits against the user's left leg (e.g. the upper left thigh) and thereby hinders the chain saw from cutting the users left upper thigh or lower legs or feet. In other words, when the users left leg fits against the concave contour, the left leg becomes locked in that position by the curvature of the concave contour, and therefore, the movement of the chainsaw towards the extremities of the left leg is hindered. Hence, the concave contour functions as a support for the leg and provides a good ergonomic solution since the chainsaw comes closer to the body and makes a better and safer handling for the user when operating the chainsaw. In the present invention, the term ergonomic chainsaw is used to define a chainsaw which has design and configuration features, which when the chainsaw is used, will maximize productivity by minimizing operating fatigue and discomfort.

Similarly, injuries caused by “kickback” is also eliminated for analogous reasons. As previously disclosed, when the user operator grips the saw by the handles, the chain naturally sets dangerously close to the left leg of the user. This position becomes even more pronounced and hazardous when the user becomes fatigued and therefore brings the saw closer to the body which in turn angles the chainsaw even further left. However, the present invention hinders “kickback” since the user can bring the concave contour of the chainsaw against his left leg and thereby support the weight of the chainsaw on his leg. As a result, the curvature of the concave contour locks the left leg to the chainsaw and thereby the movement of the chainsaw towards the extremities of the left leg becomes difficult. Since the leg also acts as a support for the chainsaw, the user is fatigued to a lesser extent and there is also less discomfort for the user.

The curvature of the chainsaw according to the present invention can also be pressed against the hip in order to reduce or eliminate the risk of cutting the left and/or right legs.

In the above described embodiment of the invention, when the concave contour is pressed against the left leg (or right hip), the concave contour is on the side of the chainsaw facing towards the left leg (or right hip) of the user. The user of this embodiment is preferably a right-handed user. In an alternative embodiment of the invention, the chainsaw is adapted for a left-handed user who will bring the concave contour against his right leg (or left hip).

The curvature of the concave contour is dictated by its radius of curvature, which controls how “steep” or “flat” the concave contour is. The larger the radius of curvature, the flatter the curvature of the concave contour. Conversely, the shorter the radius of curvature, the steeper the curvature of the concave contour. For instance, Earth, which has a relatively large radius of curvature, appears quite flat to us as we walk across it. However, a boulder—which has a much shorter radius of curvature—would appear quite steep to us as we walked across its surface.

Two examples of concave contours are illustrated in FIG. 1. The concave contours shown in FIGS. 1(a) and 1(b) have the same radius of curvature, however, the lengths of the curvatures are different. The length of the curvature is the distance between the beginning of the curvature 25 and the end of the curvature 35.

It is not only the concave contour 15 which will be in contact with the user's leg or hip. The parts of the side portion which are configured to be in contact with the user's body 45, other than the concave contour, is 2 to 20 cm long and starts from the end of the curvature 35 of the concave contour closest to the rear portion of the chainsaw and extends in the longitudinal direction towards the rear portion of the chainsaw, as illustrated in FIG. 1(c).

The curvature of the concave contour has a greater degree of curvature than the general curvature of the whole side portion. This enables that the user's leg (or hip) stays in contact with the concave contour during the operation of the chainsaw. In preferred embodiments of the invention, the radius of curvature of the concave contour is 2 to 20 cm, preferably 5-17 cm, more preferably 8-14 cm, most preferably 10-12 cm.

Moreover, the concave contour extends longitudinally at the side portion so that it fits the shape of a user's leg (or hip). The longitudinal length of the curvature of the concave contour is 2 to 20 cm, preferably 5-17 cm, more preferably 8-14 cm, most preferably 10-12 cm.

The concave contour is apertureless, i.e. there are no apertures, holes, openings or exhausts at the concave contour. Usually these types of apertures are present on one or more side portions of prior art chainsaws in order to let heat escape from the inside of the motor housing to the outside of the motor housing. Some typical examples of apertures from prior art documents is illustrated in FIG. 5 in U.S. Pat. No. 3,651,839. One disadvantage with the chainsaw disclosed in U.S. Pat. No. 3,651,839 is that the user will lean his leg or hip against the apertures when he is tired in order to support the chainsaw. However, the heat escaping from the apertures is not only a discomfort, but will also make the user fatigued which will increase the risk of lacerations and other types of injuries. Hence, in preferred embodiments of the invention, the concave contour is apertureless in order to reduce or eliminate the risk of the user becoming fatigued, i.e. in order to provide a safer chainsaw. Moreover, the concave contour being apertureless also reduces discomfort.

In some embodiments, the parts of the side portion which will be in contact with the user's body is apertureless; said parts are shown as feature (45) in FIG. 1(c). The parts of the side portion which will be in contact with the user's body is 2-20 cm long and starts from the end of the curvature closest to the rear portion of the chainsaw and extends in the longitudinal direction towards the rear portion of the chainsaw. This feature reduces or eliminates the risk of the user becoming fatigued by the warm air originating from the motor. Moreover, this features also reduces discomfort. Consequently, the risk of injuries is also reduced or eliminated.

The concave contour is substantially in contact with a convex contour of a user's leg. 30-100% of the surface of said concave contour is in contact with the user's leg, preferably 50-100% of the surface of said concave contour is in contact with the user's leg, more preferably 70-100% of the surface of said concave contour is in contact with the user's leg, most preferably 90-100% of the surface of said concave contour is in contact with the user's leg.

In some embodiments of the invention, the chainsaw comprises a chain brake lever at the front portion of the motor housing. The chain brake lever is positioned on the top portion of the front portion of the motor housing.

### EXAMPLES

### Example 1

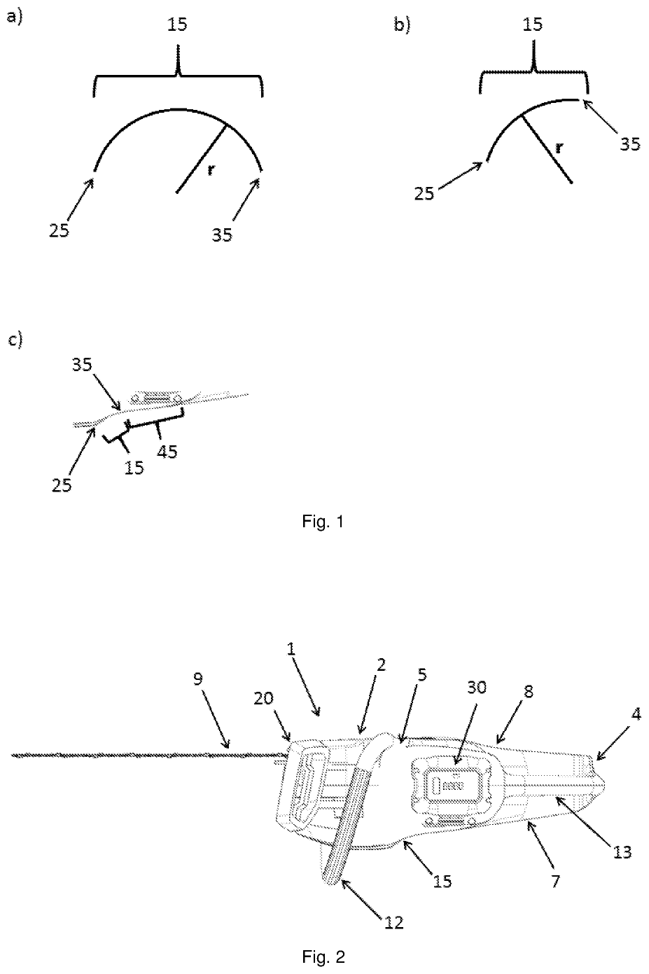

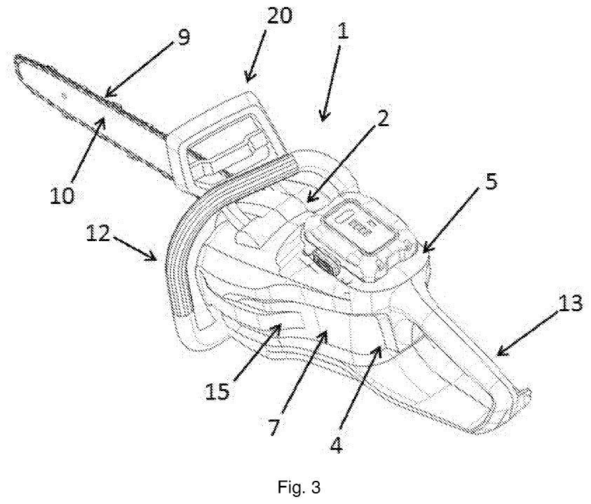

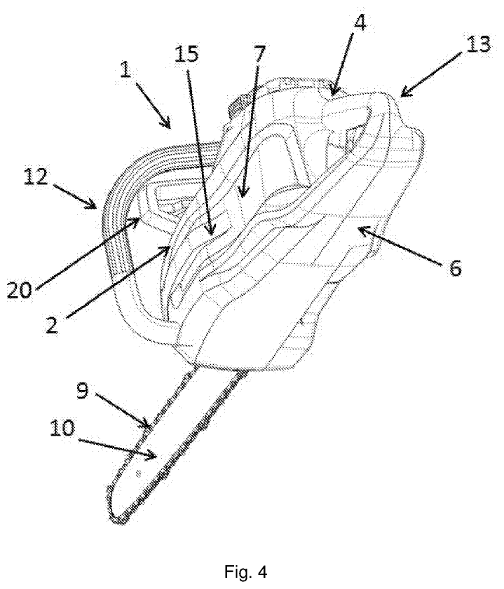

Example 1 relates to a specific embodiment of the present invention. The chainsaw (1) may comprises as illustrated in FIG. 2-4:
a. a motor housing (2) having
   i. a front portion (3),
   ii. a rear portion (4),
   iii. a top portion (5),
   iv. a bottom portion (6),
   v. a first side portion (7), i.e. left side portion when the user is facing the chain, and
   vi. a second side portion (8), i.e. right side portion when the user is facing the chain,
b. a chain (9) and a guide bar (10) for guiding the chain, wherein the chain (9) and the guide bar (10) protrude from the front portion (3) the chainsaw (1),
c. an electric motor for driving the chain (9), wherein said motor is contained in the motor housing (2) of the chainsaw,
d. a hand graspable front handle (12) which extends transversely at the front portion (3) of the motor housing,
e. a hand graspable rear handle (13) which extends longitudinally at the rear portion (4) of the motor housing,
f. a plurality of apertures for letting heat escape from the inside of the motor housing (2),
g. a chain brake lever (20), and
h. a power source (30).

In the embodiment shown in FIG. 1-3, the power source (30) is a battery pack. However, a fuel-cell or solar panel may also be used as a power source. Alternatively, the chainsaw may also be connected to a power source via a power cord.

The motor housing comprises a concave contour (15) on part of the surface of the first side portion. The curvature of the concave contour is preferably configured for fitting against a part of the leg (or hip) of a user. This feature gives a good ergonomic solution, moreover, the chainsaw comes closer to the body and makes safer handling for the user when operating the product.

As illustrated in FIGS. 2-4, the curvature of the concave contour (15) has a greater degree of curvature than the general curvature of the whole side portion. This ensures that the user's leg (or hip) stays in contact with the concave contour during the operation of the chainsaw. Preferably, the concave contour will be in contact with a convex contour of a user's leg. Moreover, the concave contour extends longitudinally at the side portion so that it fits the shape of a user's leg (or hip). The concave contour is apertureless so that the user doesn't (i) feel discomfort, and (ii) become fatigued due to the heat originating from the motor.

It has been unexpectedly discovered that the combination of having a concave contour and an apertureless concave contour provides (i) an ergonomic chainsaw, and (ii) safer operation of the chainsaw.

### REFERENCES

1. Ball, J. et al. PREVENTING CHAIN SAW INJURY—THE POWER OF TRAINING AND PERSONAL PROTECTIVE EQUIPMENT, Arborist News, p. 12-17

1-13. (canceled)

14. A portable chainsaw with motorized chain suitable for sawing and trimming objects, comprising,
a. a motor housing comprising a side portion,
b. a chain and a guide bar for guiding the chain,
c. an electric motor for driving the chain, wherein said motor is contained in the motor housing of the chainsaw,
d. a front handle,
characterized in that
the motor housing comprises a concave contour on part of the surface of the side portion.

15. Chainsaw according to claim 14, wherein the curvature of the concave contour is configured for fitting against a part of the leg of a user.

16. Chainsaw according to claim 14, wherein the curvature of the concave contour on part of the surface has a greater degree of curvature than the general curvature of the whole side portion.

17. Chainsaw according to claim 14, wherein the concave contour extends longitudinally at said side portion.

18. Chainsaw according to claim 14, wherein the concave contour is apertureless.

19. Chainsaw according to claim 14, wherein the radius of the curvature of the concave contour is 2 to 20 cm, preferably 5-17 cm, more preferably 8-14 cm, most preferably 10-12 cm.

20. Chainsaw according to claim 14, wherein the longitudinal length of the curvature of the concave contour is 2 to 20 cm, preferably 5-17 cm, more preferably 8-14 cm, most preferably 10-12 cm.

21. Chainsaw according to claim 14, wherein the part of the side portion which is configured to be in contact with the user's leg or hip is apertureless.

22. Chainsaw according to claim 14,
wherein the concave contour is apertureless,
wherein the longitudinal length of the curvature of the concave contour is 2 to 20 cm, preferably 5-17 cm, more preferably 8-14 cm, most preferably 10-12 cm, and
wherein the radius of the curvature of the concave contour is 2 to 20 cm, preferably 5-17 cm, more preferably 8-14 cm, most preferably 10-12 cm.

23. Chainsaw according to claim 14, wherein the part of the side portion which is configured to be in contact with the user's body, other than the concave contour, is 2 to 20 cm long and starts from the end of the curvature of the concave contour closest to the rear portion of the chainsaw and extends in the longitudinal direction towards the rear portion of the chainsaw.

24. Chainsaw according to claim 14, wherein the concave contour is configured for being in contact with a convex contour of a user's leg.

25. Chainsaw according to claim 14, wherein 30-100% of the surface of the concave contour is configured to be in contact with a convex contour of a user's leg.

26. Chainsaw according to claim 14, further comprising an electric motor powered by at least one of a battery pack, fuel-cell, solar panel and power cord.
